(19) United States
(12) Patent Application Publication
(10) Pub. No.: US 2026/0241855 A1
(43) Pub. Date: Aug. 20, 2026

(54) REFUSE VEHICLE WITH UNIVERSAL LIGHT ASSEMBLY

(71) Applicant: Oshkosh Corporation, Oshkosh, WI (US)

(72) Inventors: Leslie Schwartz, Owatonna, MN (US); Troy Meyers, Oshkosh, WI (US); Tony Myhre, Oshkosh, WI (US)

(73) Assignee: Oshkosh Corporation, Oshkosh, WI (US)

(21) Appl. No.: 19/541,061

(22) Filed: Feb. 16, 2026

Related U.S. Application Data
(60) Provisional application No. 63/759,467, filed on Feb. 17, 2025.

(51) Int. Cl. B60Q 1/26; B65F 3/02; B65F 3/04

(52) U.S. Cl. CPC B60Q 1/2661; B65F 3/04; B65F 2003/0283

(57) ABSTRACT

A refuse vehicle includes a tailgate and a lighting assembly. The tailgate includes a lift apparatus configured to raise a refuse container and empty contents of the refuse container into a hopper. The lighting assembly includes a bracket, a first adapter, and a light. The bracket is coupled with a frame of the tailgate. The bracket defines openings having a universal size and spacing. The first adapter includes a first plate and a second plate. The first plate defines a first engagement surface and having a first plurality of openings corresponding in size and spacing to the plurality of openings of the bracket. The second plate defines a second engagement surface having a second plurality of openings. The first plate and the second plate are disposed in different planes relative to each other. The light includes a housing having a plurality of openings corresponding in size and spacing to the second plurality of openings in the second plate.

### CROSS-REFERENCE TO RELATED PATENT APPLICATION

This application claims the benefit of and priority to U.S. Provisional Application No. 63/759,467, filed Feb. 17, 2025, the entire disclosure of which is incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One implementation of the present disclosure relates to a refuse vehicle. The refuse vehicle includes a tailgate, and a lighting assembly. The tailgate includes a lift apparatus configured to raise a refuse container and empty contents of the refuse container into a hopper. The lighting assembly includes a bracket, a first adapter, and a light. The bracket is coupled with a frame of the tailgate. The bracket defines multiple openings having a universal size and spacing. The first adapter includes a first plate and a second plate. The first plate defines a first engagement surface and having a first plurality of openings corresponding in size and spacing to the plurality of openings of the bracket. The second plate defines a second engagement surface having a second plurality of openings. The first plate and the second plate are disposed in different planes relative to each other. The light includes a housing having a plurality of openings corresponding in size and spacing to the second plurality of openings in the second plate.

In some embodiments, the first adapter includes a medial portion extending between the first plate and the second plate. In some embodiments, the first plate and the second plate of the first adapter extend from opposite sides at opposite ends of the medial portion in directions perpendicular to the medial portion.

In some embodiments, the first adapter includes a medial portion extending between the first plate and the second plate. In some embodiments, the first plate and the second plate of the first adapter extend from a same side at opposite ends of the medial portion in directions perpendicular to the medial portion.

In some embodiments, the bracket is configured to couple with the first adapter or a second adapter having a first plurality of openings corresponding in size and spacing to the plurality of openings of the bracket. In some embodiments, a second plate of the second adapter is disposed in a different plane than a plane in which the second plate of the first adapter is disposed. In some embodiments, a medial portion of the second adapter is longer than the medial portion of the first adapter to result.

In some embodiments, the bracket is a universal bracket that is configured to couple with a plurality of different adapters having openings corresponding in size and spacing to the plurality of openings of the bracket to reposition the light in a plurality of various positions or orientations. In some embodiments, the bracket is configured to couple with the first adapter or a second adapter having a first plurality of openings corresponding in size and spacing to the plurality of openings of the bracket. In some embodiments, a second plate of the second adapter is disposed in a different plane than a plane in which the second plate of the first adapter is disposed. In some embodiments, the first adapter is configured to position the light laterally outwards from the bracket.

Another implementation of the present disclosure is a kit for a lighting assembly. In some embodiments, the kit includes a bracket, multiple adapters, and a light. The bracket includes a universal bolt hole pattern. Each of the adapters includes (i) a first engagement surface configured to abut the bracket and including multiple first openings corresponding in sizing and spacing to the universal bolt hole pattern, and (ii) a second engagement surface having multiple second openings. The light can include a housing configured to be fastened to a second engagement surface of each of the adapters in a vertical orientation or a horizontal orientation. The housing includes openings having bolt hole patterns corresponding to a bolt hole pattern of the second openings of the adapters. The adapters can be interchangeable with each other on the bracket. The adapters can each result in the light, when assembled, being in a different position or orientation.

In some embodiments, the adapters include a first adapter, the first adapter including a first plate having an angle corresponding to the bracket, a medial portion, and a second plate, the second plate angled relative to the first plate such that, when the first adapter is installed on a refuse vehicle, the light is oriented in a vertical direction and faces rearwards.

In some embodiments, the adapters include a second adapter. In some embodiments, the second adapter includes a first plate and a second plate. The first plate has an angle corresponding to the bracket. The second plate is angled relative to the first plate such that, when the second adapter is installed on the refuse vehicle, the light is oriented in a horizontal direction and faces rearwards.

In some embodiments, the adapters include a third adapter. The third adapter includes a first plate having an angle corresponding to the bracket, a medial portion, and a second plate. The second plate is angled relative to the first plate such that, when the third adapter is installed on the refuse vehicle, the light is oriented in a vertical direction and faces rearwards. In some embodiments, the medial portion of the third adapter is longer than the medial portion of the first adapter.

In some embodiments, the adapters include a fourth adapter. The fourth adapter includes a first plate having an angle corresponding to the bracket, a medial portion, and a second plate. The second plate is angled relative to the first plate such that, when the third adapter is installed on the refuse vehicle, the light is oriented in a vertical direction and faces rearwards. In some embodiments, the first plate and the second plate extend from a same side of the medial portion.

In some embodiments, the adapters include a fifth adapter, the fifth adapter including a first plate and a second plate, the first plate and the second plate being perpendicular to each other. In some embodiments, the first plate includes a first pair of slots and the second plate includes a second pair of slots. The first pair of slots and the second pair of slots are perpendicular with each other such that the light is capable of being repositioned in multiple directions.

In some embodiments, the kit includes multiple fasteners. The fasteners are configured for use with any of the adapters to (i) couple the light to any of the plurality of adapters, (ii) couple any of the plurality of adapters to the bracket, and (iii) couple the bracket to a refuse vehicle.

Another implementation of the present disclosure is a lighting assembly for a refuse vehicle. The lighting assembly includes a bracket, a first adapter, and a light. The bracket is coupled with a frame of a tailgate of the refuse vehicle. The bracket defines multiple openings having a universal size and spacing. The first adapter includes a first plate, and a second plate. The first plate defines a first engagement surface and has first openings corresponding in size and spacing to the openings of the bracket. The second plate defines a second engagement surface and has second openings. The first plate and the second plate are disposed in different planes relative to each other. The light includes a housing having multiple openings corresponding in size and spacing to the second openings in the second plate.

In some embodiments, the first adapter includes a medial portion extending between the first plate and the second plate. In some embodiments, the first plate and the second plate of the first adapter extend from opposite sides at opposite ends of the medial portion in directions perpendicular to the medial portion.

In some embodiments, the first adapter includes a medial portion extending between the first plate and the second plate. In some embodiments, the first plate and the second plate of the first adapter extend from a same side at opposite ends of the medial portion in directions perpendicular to the medial portion.

In some embodiments, the bracket is a universal bracket that is configured to couple with multiple different adapters having openings corresponding in size and spacing to the openings of the bracket to reposition the light in various positions or orientations.

In some embodiments, the bracket is configured to couple with the first adapter or a second adapter having first openings corresponding in size and spacing to the openings of the bracket. In some embodiments, a second plate of the second adapter is disposed in a different plane than a plane in which the second plate of the first adapter is disposed.

In some embodiments, the bracket is configured to couple with the first adapter or a second adapter having first openings corresponding in size and spacing to the openings of the bracket. In some embodiments, a second plate of the second adapter is disposed in a different plane than a plane in which the second plate of the first adapter is disposed. In some embodiments, a medial portion of the second adapter is longer than the medial portion of the first adapter.

### BRIEF DESCRIPTION OF THE DRAWINGS

FIG. 1 is a front perspective view of a refuse vehicle, according to an exemplary embodiment.

FIG. 2 is a rear perspective of the refuse vehicle of FIG. 1 having a rear lift assembly, according to an exemplary embodiment.

FIG. 3 is a rear perspective view of a tailgate of the refuse vehicle of FIG. 1 including a bracket for a lighting assembly, according to some embodiments.

FIG. 4 is a perspective vie of the bracket, according to some embodiments.

FIG. 5 is a perspective view of the tailgate of FIG. 3 including two of the brackets disposed on opposite frame members, according to some embodiments.

FIG. 6 is an exploded view of a lighting assembly for a first tailgate including a first adapter, according to some embodiments.

FIG. 7 is an exploded view of a portion of a light and the first adapter of the lighting assembly of FIG. 6, according to some embodiments.

FIG. 8 is another exploded view of the first adapter and the light on a second side of the lighting assembly of FIG. 6, according to some embodiments.

FIG. 9 is a perspective view of the first adapter, according to some embodiments.

FIG. 10 is a side view of the first adapter, according to some embodiments.

FIG. 11 is a perspective view of the lighting assembly including a second adapter, according to some embodiments.

FIG. 12 is a perspective view of the second adapter, according to some embodiments.

FIG. 13 is a side view of the second adapter, according to some embodiments.

FIG. 14 is a perspective view of a third adapter, according to some embodiments.

FIG. 15 is a side view of the third adapter, according to some embodiments.

FIG. 16 is a perspective view of the lighting assembly including a fourth adapter, according to some embodiments.

FIG. 17 is a perspective view of the fourth adapter, according to some embodiments.

FIG. 18 is a side view of the fourth adapter, according to some embodiments.

FIG. 19 is a perspective view of the lighting assembly including a bracket configured to be directly coupled with housings of lights, according to some embodiments.

FIG. 20 is another perspective view of the lighting assembly of FIG. 19, according to some embodiments.

FIG. 21 is a perspective view of the lighting assembly including a fifth adapter, according to some embodiments.

FIG. 22 is a perspective view of the lighting assembly of FIG. 21, according to some embodiments.

FIG. 23 is a perspective view of the fifth adapter, according to some embodiments.

FIG. 24 is a block diagram of a kit for the lighting assembly of FIGS. 3-23, according to some embodiments.

FIG. 25 is a flow diagram of a method for installing a lighting assembly, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a tailgate lighting system for a refuse vehicle is shown, according to various exemplary embodiments. The tailgate lighting system includes a housing configured to support at least one (e.g., a pair, etc.) of light elements onboard the refuse vehicle. The tailgate lighting system also includes a universal bracket that may be welded or otherwise fastened to the tailgate of a rear loading refuse vehicle. The tailgate lighting system further includes an adapter that is configured to support the housing on the universal bracket and at different orientations relative to the bracket. For example, the lighting system may enable mounting of the housing in different orientations relative to the universal bracket (e.g., a horizontal orientations with lights arranged side-by-side, a vertical orientation with light elements positioned above and below one another along a vertical direction relative to a ground surface, etc.). The lighting system may also be configured to enable spacing of the housing and tailgate light elements at different distances and angles relative to the universal bracket. Such an implementation can accommodate various different vehicle applications, rear tipper, and/or tailgate designs.

According to an exemplary embodiment, a refuse vehicle includes a rear lift assembly coupled to a tailgate of the refuse vehicle. The rear lift assembly includes a base, an electric actuator coupled to the base, an implement, and an arm extending between the electric actuator and the implement such that the implement is pivotally coupled to the base. The electric actuator is configured to pivot the implement between a first position and a second position to facilitate emptying contents from a refuse container interfacing with the implement into a refuse compartment of the refuse vehicle through the tailgate.

According to an exemplary embodiment, a lighting system for rear loading refuse vehicles is shown including a bracket having a universal bolt hole pattern. The bracket is configured to be coupled to a portion of a tailgate of a refuse vehicle (e.g., fastened or welded). The bracket is configured to be coupled with a plurality of different adapters that have various shapes and sizes. The adapters each include a first engagement surface configured to abut the bracket and having a plurality of openings corresponding in their bolt hole pattern to the bolt hole pattern of the bracket. The adapters also include a second engagement surface that is configured to abut or contact a surface of a housing of a light. The second engagement surface can include a plurality of openings having a bolt hole pattern corresponding to a bolt hole pattern in the surface of the housing. The housing of the light can include multiple sides or surfaces having multiple sets of openings, each having the same bolt hole pattern such that the light is reconfigurable between different orientations. In some embodiments, the bolt hole patterns of each side of the housing of the lights, the bolt hole patterns of each of the first engagement surface and the second engagement surface of the adapter and other adapters, and the bolt hole pattern of the bracket, are all the same such that multiple adapters can be interchanged with each other. The adapters have different shapes and sizes in order to reposition the light between different orientations and positions relative to the bracket. The adapters are interchangeable with each other such that a single type of bracket can be installed on multiple refuse vehicles having different tailgate configurations.

For example, different tailgate configurations or different lift assemblies may result in various points of view of the lights being obstructed and therefore the lights are repositioned by the use of different adapters to improve visibility. The adapters can therefore facilitate improved off-axis viewing angles (e.g., from a side of the refuse vehicle) in particular for dual-tipper embodiments of the tailgate. The adapters also facilitate improved maintenance by providing a bolt-on solution that enables maintenance personnel to easily remove and replace lights on the refuse vehicle. Using the universal bolting techniques described herein further facilitates manufacturing the adapters out of an aluminum or stainless steel material to improve longevity of the lighting assembly. The universal bolt hole pattern also facilitates replacing the housings of the lights with different housings as desired (e.g., without requiring a unique welded solution). Various of the adapters can include slots corresponding to the bolt hole pattern to facilitate adjustability of the position of the lights.

Another exemplary embodiment of the present application relates to a method of installing tailgate lights on a refuse vehicle. The method includes coupling a first wall of an adapter arranged at a first orientation with a universal bracket that is welded or otherwise affixed to the refuse vehicle; coupling a housing of a light assembly to a second wall of the adapter that is spaced apart from the first wall and is oriented in a second orientation that is different from the first orientation and/or from the orientation of the universal mounting bracket.

### Overall Vehicle

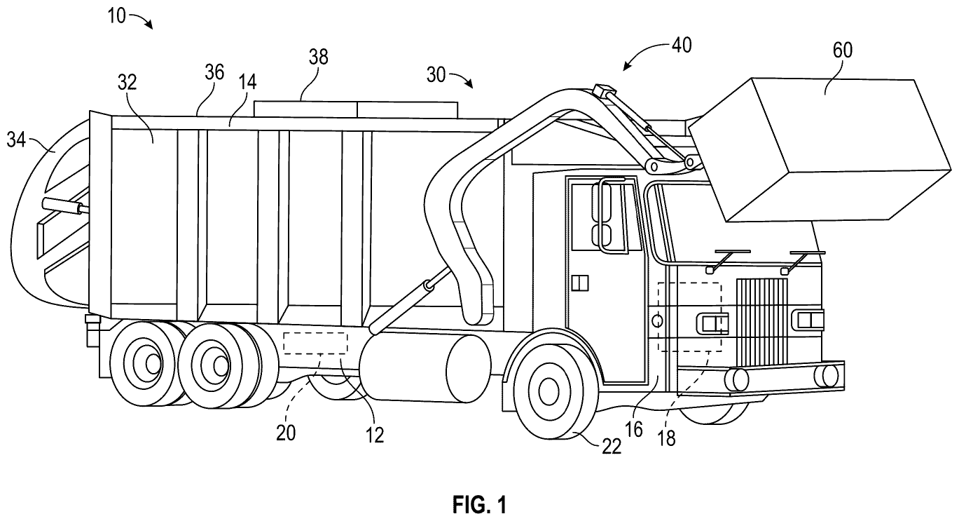

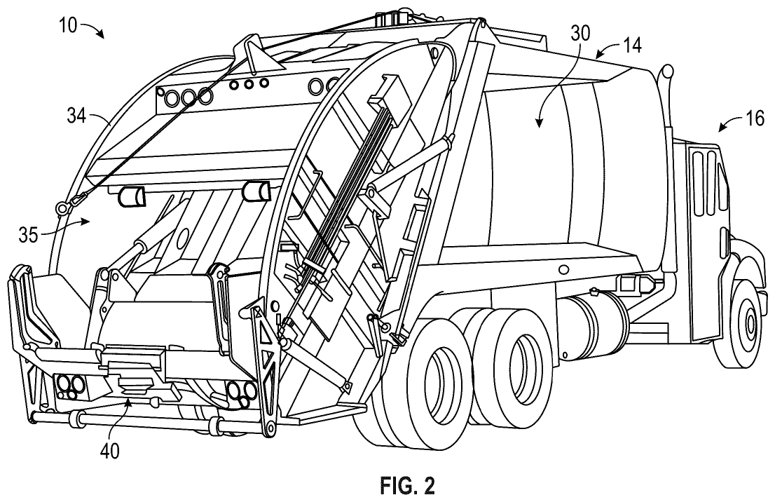

As shown in FIG. 1, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck (see, e.g., FIG. 2). In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as electric motor 18, and an energy system, shown as energy storage and/or generation system 20. In other embodiments, the prime mover is or includes an internal combustion engine. According to the exemplary embodiment shown in FIG. 1, the electric motor 18 is coupled to the frame 12 at a position beneath the cab 16. The electric motor 18 is configured to provide power to a plurality of tractive elements, shown as wheels 22 (e.g., via a drive shaft, axles, etc.). In other embodiments, the electric motor 18 is otherwise positioned and/or the refuse vehicle 10 includes a plurality of electric motors to facilitate independently driving one or more of the wheels 22. In still other embodiments, the electric motor 18 or a secondary electric motor is coupled to and configured to drive a hydraulic system that powers hydraulic actuators. According to the exemplary embodiment shown in FIG. 1, the energy storage and/or generation system 20 is coupled to the frame 12 beneath the body 14. In other embodiments, the energy storage and/or generation system 20 is otherwise positioned (e.g., within a tailgate of the refuse vehicle 10, beneath the cab 16, along the top of the body 14, within the body 14, etc.).

According to an exemplary embodiment, the energy storage and/or generation system 20 is configured to (a) receive, generate, and/or store power and (b) provide electric power to (i) the electric motor 18 to drive the wheels 22, (ii) electric actuators of the refuse vehicle 10 to facilitate operation thereof (e.g., lift actuators, tailgate actuators, packer actuators, grabber actuators, etc.), and/or (iii) other electrically operated accessories of the refuse vehicle 10 (e.g., displays, lights, etc.). The energy storage and/or generation system 20 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In one embodiment, the refuse vehicle 10 is a completely electric refuse vehicle. In other embodiments, the refuse vehicle 10 includes an internal combustion generator that utilizes one or more fuels (e.g., gasoline, diesel, propane, natural gas, hydrogen, etc.) to generate electricity to charge the energy storage and/or generation system 20, power the electric motor 18, power the electric actuators, and/or power the other electrically operated accessories (e.g., a hybrid refuse vehicle, etc.). For example, the refuse vehicle 10 may have an internal combustion engine augmented by the electric motor 18 to cooperatively provide power to the wheels 22. The energy storage and/or generation system 20 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 10. In some embodiments, the energy storage and/or generation system 20 includes a heat management system (e.g., liquid cooling, heat exchanger, air cooling, etc.).

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30, a front-loading refuse vehicle, a side-loading refuse vehicle, etc.). In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

### Rear-Loading Lift Assembly and Lights

As shown in FIG. 2, the lift assembly 40 is configured as a rear-loading lift assembly. According to an exemplary embodiment shown in FIG. 2, the lift assembly 40 is configured to facilitate lifting the refuse container 60 to dump the contents therein (e.g., trash, recyclables, etc.) into the refuse compartment 30 through an opening, shown as hopper opening 35, in the tailgate 34. The lift assembly 40 can be a tipper assembly that includes a prime mover (e.g., an electric motor, a hydraulic motor or actuator, a pneumatic motor, etc.). The prime mover can drive one or more linkages or members to rotate in order to tip the refuse container 60 to dump the contents into the refuse compartment 30 through the hopper opening 35. The lift assembly 40 can be provided in a variety of configurations such as to lift or tip a dumpster, individual residential garbage cans, etc.

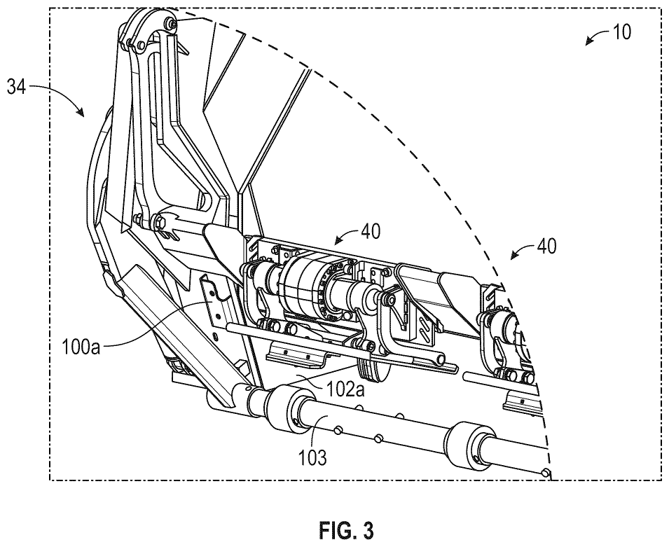

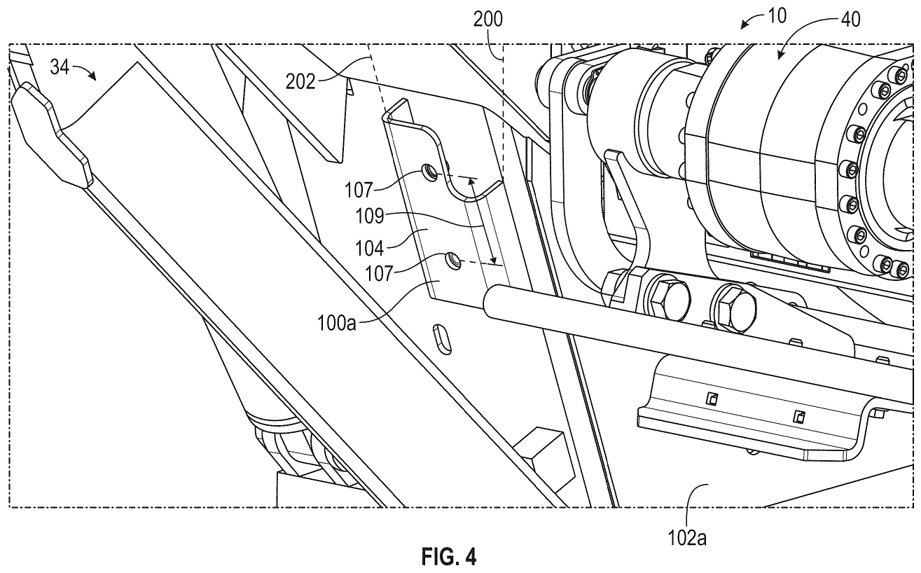

Referring to FIGS. 3-5, the tailgate 34 includes a lighting assembly 150 (e.g., a light assembly, an illuminating assembly, an illumination assembly, a tail light assembly, a brake light assembly, etc.). The lighting assembly 150 includes a first bracket 100a (e.g., a support member, a frame member, a coupler, a flange, etc.). The first bracket 100a is coupled with (e.g., welded to, bolted to, integrally formed with, etc.) a first frame member 102a (e.g., a housing member, a support, etc.) of the tailgate 34. The first frame member 102a extends in a longitudinal direction relative to the refuse vehicle 10. The first bracket 100a can have an L-shape including a first portion that is welded to the first frame member 102a and a second portion that protrudes rearwardly from an end of the first frame member 102a. The first portion and the second portion can form a 90 degree angle between each other. The first bracket 100a defines an engagement surface 104 along the second portion that faces rearward. The engagement surface 104 can be disposed along an axis 202 that is angled relative to a vertical axis 200. The vertical axis 200 can be defined as normal to a ground surface upon which the refuse vehicle 10 is positioned. The engagement surface 104 can be oriented in a rearward and downwards towards the ground surface at the angle formed between the axis 202 and the vertical axis 200. The engagement surface 104 can be generally perpendicular with or normal to the first frame member 102a. As shown in FIGS. 3-5, the brackets 100 are coupled to the frame members 102 a distance above a bottom edge of the frame members 102 in order to reduce a likelihood of the lights 108 being torn off or broken during operation of the tailgate 34.

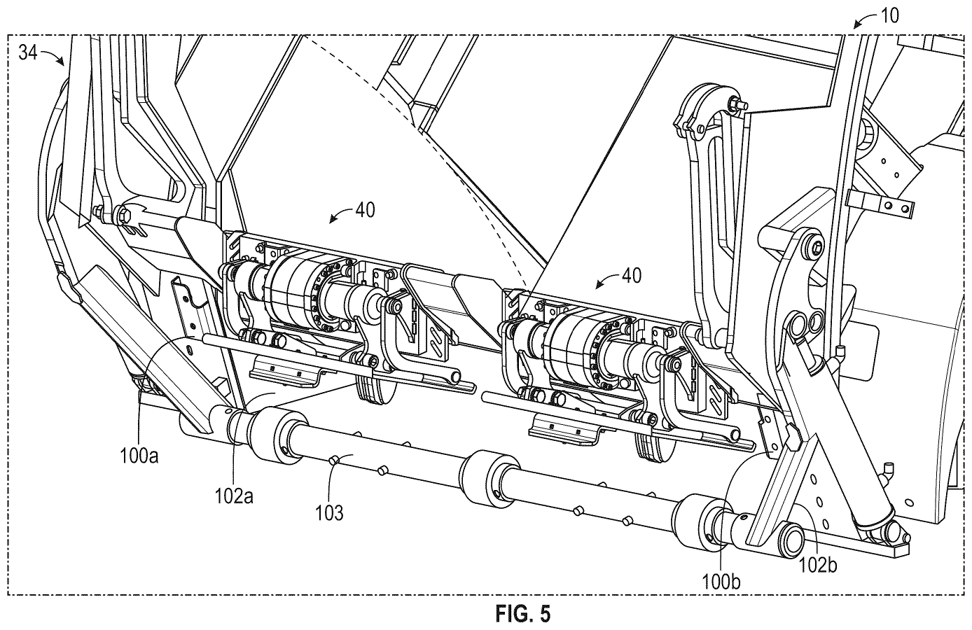

The engagement surface 104 includes a pair of openings 107 disposed at various locations along the engagement surface 104. The openings 107 are configured to receive fasteners to couple the first bracket 100a with an adapter (e.g., a first adapter 106). The openings 107 can be disposed a distance 109 apart along the bracket 100a. In particular, the openings 107 define a universal bolt hole pattern that can be the same across multiple adapters (e.g., adapter 106, adapter 206, adapter 306, adapter 406, and adapter 506). As shown in FIG. 5, the tailgate 34 includes a pair of the frame members 102, shown as the first frame member 102a and a second frame member 102b. The first frame member 102a and the second frame member 102b are parallel with each other and can extend in a generally rearward direction along the tailgate 34. The first frame member 102a and the second frame member 102b are spaced apart from each other in a lateral direction and are positioned at opposite sides or ends of an area where the refuse container 60 is disposed when lifted by the lift assembly 40. The lift assembly 40 can be positioned at least partially between the first frame member 102a and the second frame member 102b. The tailgate 34 can also include a kick bar 103 that extends generally between the first frame member 102a and the second frame member 102b. The first frame member 102a and the second frame member 102b can be symmetrical with each other. The second frame member 102b can also include a second bracket 100b that is coupled with the second frame member 102b in a mirror image arrangement as the first bracket 100a and the first frame member 102a. The first bracket 100a and the second bracket 100b can protrude in opposite directions. In particular, the engagement surface 104 of the first bracket 100a and the second bracket 100b extend in laterally outwards directions from outer surface of the first frame member 102a and the second frame member 102b. The first adapter 106 can be used for a tag-axle configuration of the refuse vehicle 10. The brackets 100 can include nuts welded to a surface of the brackets 100 at the openings 107 opposite the engagement surface 104.

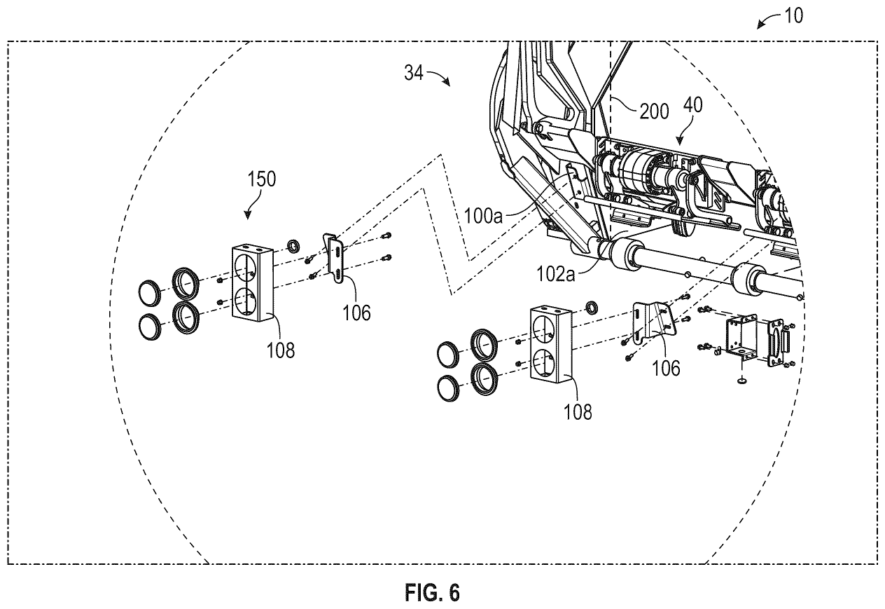

Referring to FIG. 6-8, the lighting assembly 150 of the tailgate 34 includes a pair of adapters 106 (e.g., brackets) and a pair of lights 108 (e.g., tail lights, brake lights, illuminating lights, turn indicators, etc.). Each of the adapters 106 are configured to couple, at a first engagement surface, with a corresponding one of the brackets 100, and at a second engagement surface, with a corresponding one of the lights 108. The adapters 106 can be configured to adjust an orientation or position of the lights 108 relative to the brackets 100 in order to improve visibility of the lights 108. The adapters 106 are also coupled with the brackets 100 and the lights 108 (e.g., housings of the lights 108) via fasteners such that the lights 108 can easily be removed and serviced. The adapters 106 can also be configured to be replaced with other configurations of the adapters in order to provide adjustability of the position and orientation of the lights 108 as desired. For example, various configurations of the adapters 106 can include a uniform or similar first engagement surface such that the various configurations of the adapters 106 can be coupled with the brackets 100. The first engagement surface and the second engagement surface can be in different planes (e.g., at different positions and different orientations) relative to each other in order to facilitate positioning the lights 108 at a desired position based on a configuration or model of the lift apparatus 40 that is installed on the tailgate 34.

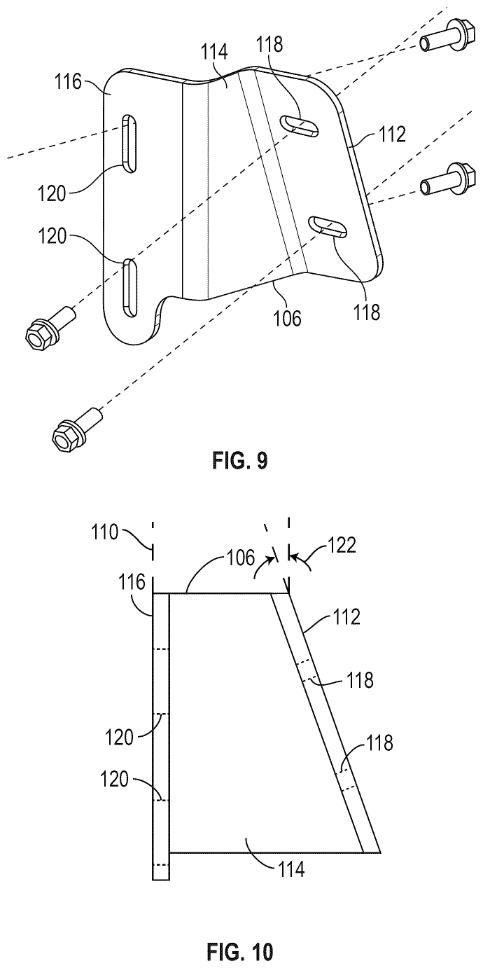

Referring to FIGS. 9 and 10, one of the adapters 106 according to a first configuration is shown. The first adapter 106 includes a first plate 112, a medial portion 114, and a second plate 116. The medial portion 114 extends between the first plate 112 and the second plate 116. The first plate 112 defines the first engagement surface that is configured to abut the engagement surface 104 of the bracket 100. The second plate 116 is configured to define the second engagement surface at which the light 108 is configured to couple with the first adapter 106. The first plate 112, the medial portion 114, and the second plate 116 are integrally formed with each other. The first plate 112 can protrude from a first side of the medial portion 114 while the second plate 116 protrudes from a second side of the medial portion 114 that is opposite the first side. The first plate 112 is angled relative to the vertical axis 200 an angle 125 corresponding to (e.g., equal to) the angle formed between the axis 202 and the vertical axis 200. In this way, the second plate 116 and the second engagement surface extend along an axis 110 that is parallel with the vertical axis 200. The second plate 116 therefore extends in the vertical direction along the vertical axis 200. The light 108 therefore, when coupled (e.g., fastened), to the second plate 116 at the second engagement surface is oriented in a generally vertical direction (e.g., in a direction perpendicular to the ground surface).

As shown in FIGS. 9 and 10, the first adapter 106 includes a first pair of openings 118 (e.g., slots, apertures, channels, etc.) that extend through the first plate 112 and a second pair of openings 120 (e.g., slots, apertures, channels, etc.) that extend through the second plate 116. The first openings 118 and the second openings 120 can extend in generally perpendicular directions. For example, the second openings 120 extend in a generally vertical direction along the second plate 116 whereas the first openings 118 extend laterally along the first plate 112. The first pair of openings 118 can have a sizing and spacing (e.g., a bolt hole pattern) corresponding to (e.g., substantially the same as) the openings 107 of the brackets 100. In some embodiments, the second openings 120 are similarly configured such that the sizing and spacing corresponds to the openings 107 of the brackets 100.

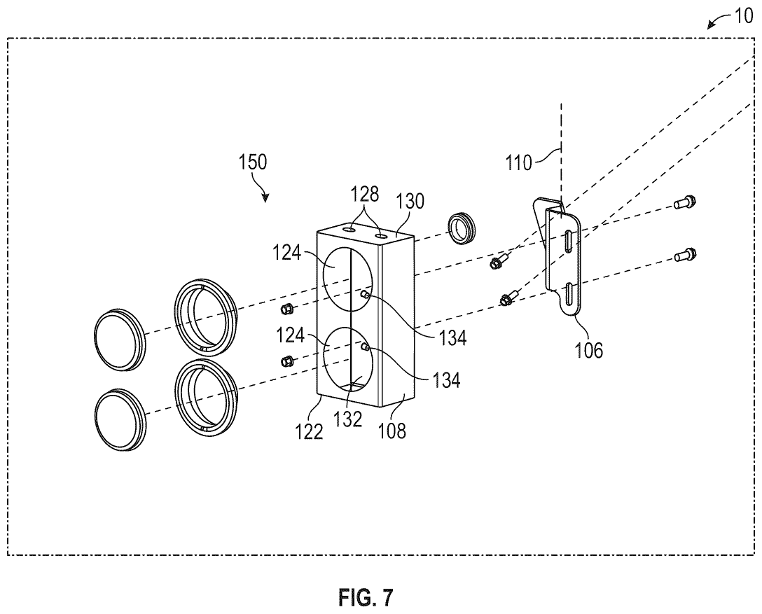

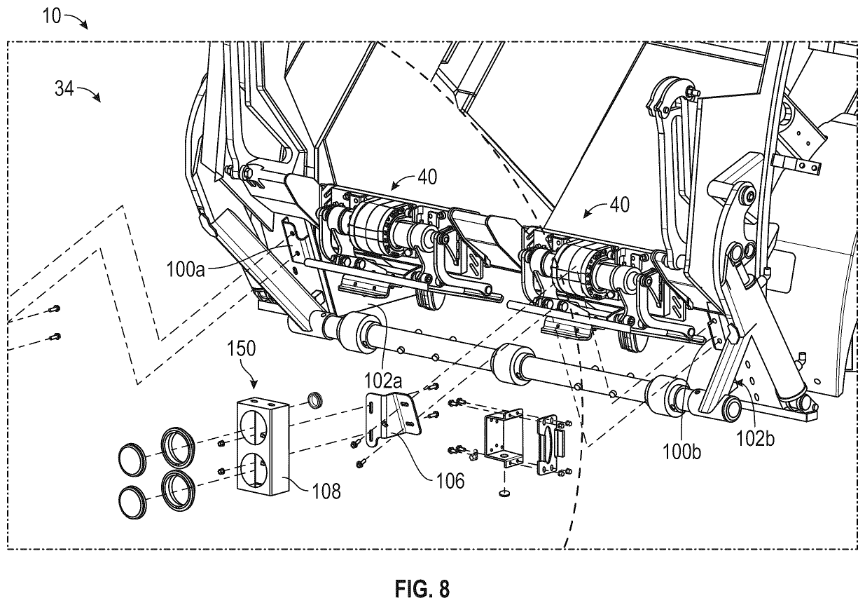

Referring to FIGS. 7 and 8, the light 108 can be coupled to the second plate 116 of the first adapter 106 such that the light 108 is oriented in the vertical direction. As shown in FIG. 7, the light 108 includes a housing 122 and a pair of lighting elements 124 that are provided in the housing 122. The lighting elements 124 (e.g., light bulbs, light emitting diodes, etc.) can be oriented either horizontally (e.g., such that the lighting elements 124 are disposed side by side with each other) or vertically (e.g., such that the lighting elements 124 are disposed in an upwards and downwards direction). The housing 122 can have a generally rectangular form including multiple sides. In particular, the housing 122 can include a front, a rear, a left side, a right side, and a top and a bottom. The front includes opening for the lighting elements 124 to be viewed through. The housing 122 can include apertures or openings formed on the rear of the housing. The openings formed on the rear of the housing 122 are configured to receive fasteners to couple the housing 122 with the first adapter 106 (e.g., to couple the light 108 with the second plate 116 of the first adapter 106). As shown in FIG. 7, the first adapter 106 is configured to couple with the light 108 at the rear of the housing 122 such that the lighting elements 124 are arranged vertically. The first adapter 106 can be coupled with the rear of the housing 122 of the light 108 via fasteners that extend through the openings 120 of the second plate 116 and the openings formed in the rear of the housing 122.

As shown in FIG. 6, the adapters 106 are mirror images of each other. The adapters 106 position the lights 108 at positions more proximate a longitudinal center of the tailgate 34 than the brackets 100. In particular, the adapters 106 (e.g., the first plate 112 and the second plate 116) extend inwards towards each other such that the lights 108 are positioned more inwards (e.g., more proximate each other) than the position of the brackets 100. The adapters 106 also facilitate orienting the lights 108 in a substantially vertical direction (e.g., in a direction substantially parallel with the vertical axis 200) by accounting for the angle formed between the vertical axis 200 and the brackets 100.

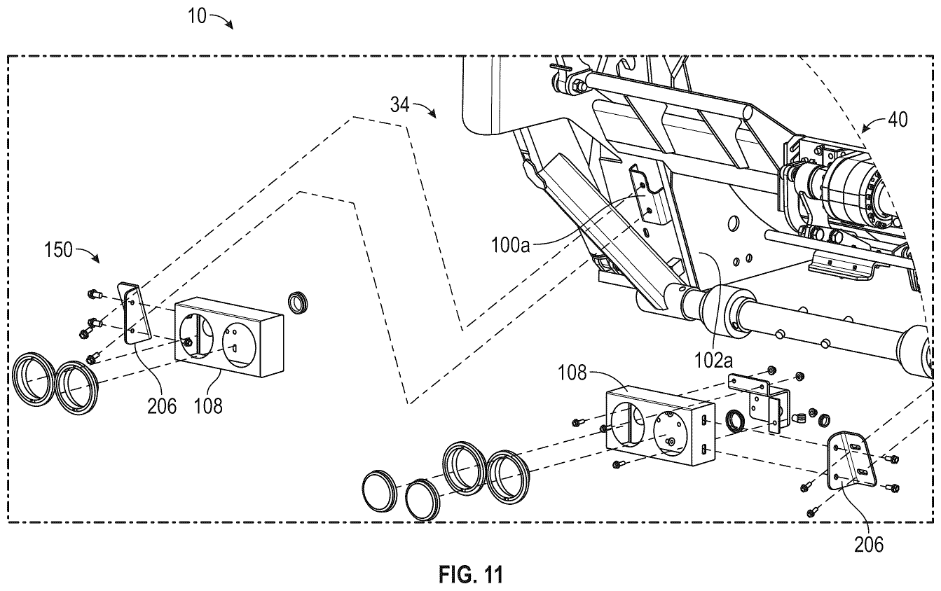

Referring to FIGS. 11-13, the brackets 100 and the lights 108 can be coupled with each other via second adapters 206 (e.g., brackets). The adapters 206 can be similar to the adapters 106 but result in a different configuration (e.g., orientation and positioning) of the lights 108 compared to the adapters 106. The adapters 206 are configured to couple with the brackets 100 similarly to the adapters 106. The brackets 100 are therefore universal brackets 100 that are configured to receive a variety of adapters having different configurations. The adapters 106 and adapters 206 can have a similar or common mounting configuration at the side that couples with the brackets 100 to advantageously facilitate swap-ability of the adapters 106 and 206 to thereby result in adjustable orientation and positioning of the lights 108. Further, various refuse vehicles 10 can have different lift apparatuses 40 having different sizes or mechanisms to lift the refuse container 60. The various lift apparatuses 40 can therefore require different positioning and orientation of the lights 108 in order to improve visibility of the lights 108. Multiple refuse vehicles 10 having different lift mechanisms that take up different amounts of space on the tailgate 34 can therefore be provided with the brackets 100 without requiring different brackets. The different lift mechanisms can be accommodated from a light perspective by installing different adapters (e.g. the adapters 106 or the adapters 206) onto the brackets 100. The first pair of openings 218 can have a sizing and spacing (e.g., a bolt hole pattern) corresponding to (e.g., substantially the same as) the openings 107 of the brackets 100. In some embodiments, the second openings 220 are similarly configured such that the sizing and spacing corresponds to the openings 107 of the brackets 100.

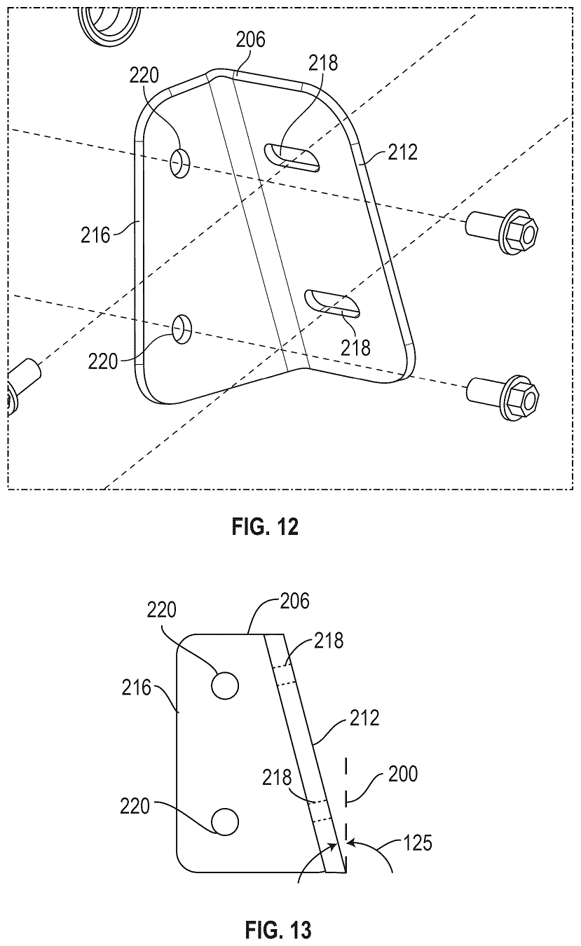

As shown in FIGS. 12 and 13, the adapters 206 include a first plate 212 and a second plate 216. The first plate 212 and the second plate 214 can be integrally formed with each other along a common edge. The first plate 212 and the second plate 214 are formed at a generally 90 degree angle relative to each other. The first plate 212 can be angled relative to the vertical axis 200 an amount corresponding to (e.g., equal to) the angular amount between the engagement surface defined by the bracket 100 and the vertical axis 200.

Referring still to FIGS. 12 and 13, the first plate 212 includes a first pair of openings 218 (e.g., slots, channels, apertures, etc.) and the second plate 216 includes a second pair of openings 220. The first plate 212 defines a first contact or engagement surface that is configured to contact (e.g., directly abut) the engagement surface of the bracket 100. The second plate 216 defines a second contact or engagement surface that is configured to contact (e.g., directly abut) the housing 122 of the light 108. The first pair of openings 218 are configured to receive fasteners to couple the first plate 212 with the bracket 100. The second pair of openings 220 are configured to receive fasteners the couple the second plate 216 with the housing 122 of the lights 108. The first engagement surface and the second engagement surface defined by the first plate 212 and the second plate 216 are, similar to the first engagement surface and the second engagement surface of the first adapter 106, at different spatial positions and orientations relative to each other.

As shown in FIG. 11, the adapters 206 are configured to couple with the housings 122 of the lights 108 such that the lighting elements 124 are disposed in the horizontal direction. The housing 122 can include openings formed in the top or bottom of the housing 122 such that, when the housing 122 is coupled with the adapters 206 at the second plate 216, the light 108 is oriented in a horizontal direction. The adapters 206 can be configured to result in the lights 108 being oriented in a generally horizontal direction (e.g. in a direction that is substantially parallel with a ground surface) and extending inwards towards each other. For example, as shown in FIG. 11, the lights 108 are oriented horizontally as opposed to vertically as when the adapters 106 are used, and the lights 108 extend inwards towards each other. The angle of the first plate 212 can also account for the angle of the brackets 100 such that the lights 108 face in a rearwards direction and are not angled downwards towards the ground surface.

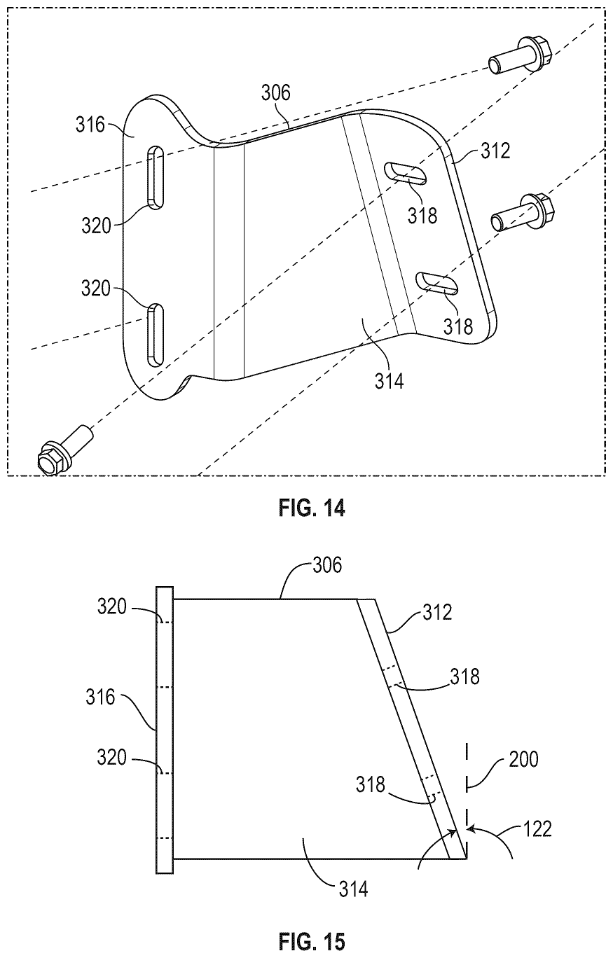

Referring to FIGS. 14 and 15, another configuration of a third adapter 306 (e.g., a bracket) is shown, according to some embodiments. The third adapter 306 is similar to the first adapter 106 and includes a first plate 312, a medial portion 314, and a second plate 316. The first plate 312, the medial portion 314, and the second plate 316 can be similar to the first plate 112, the medial portion 114, and the second plate 116 of the first adapter 106. The medial portion 314 can be longer than the medial portion 114 of the first adapter 106 such that the second plate 316 is disposed further away from the first plate 312 than the second plate 116 is disposed from the first plate 112. The first plate 312 can include openings 318 similar to the openings 118 of the first plate 112. The second plate 316 can include openings 320 similar to the openings 120 of the first adapter 106. However, the openings 320 of the second plate 316 can be disposed at a higher location on the second plate 316 than the openings 120 of the second plate 116. The third adapter 306 can be provided as a pair of third adapters 306 that are configured to be coupled with the brackets 100 at the first plates 312. The first pair of openings 318 can have a sizing and spacing (e.g., a bolt hole pattern) corresponding to (e.g., substantially the same as) the openings 107 of the brackets 100. In some embodiments, the second openings 320 are similarly configured such that the sizing and spacing corresponds to the openings 107 of the brackets 100.

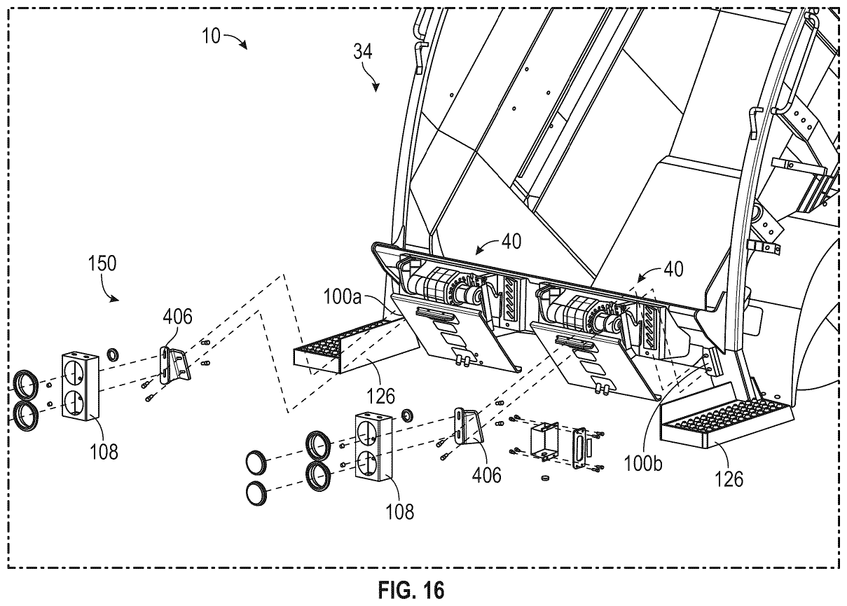

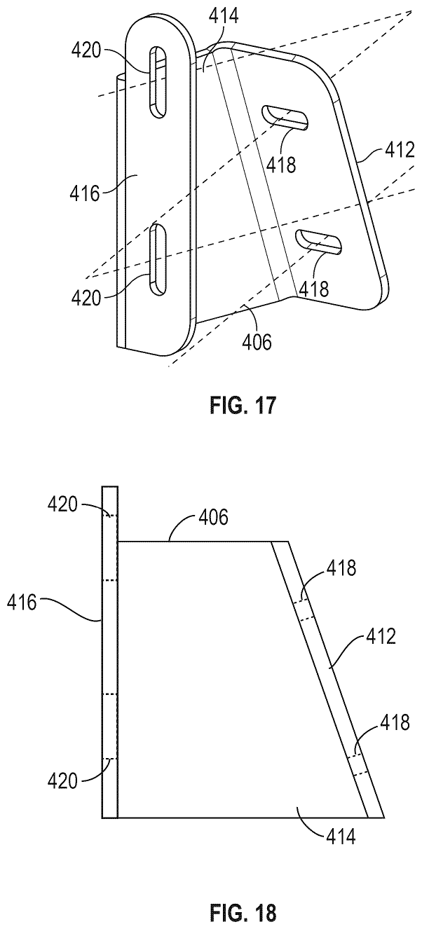

Referring to FIGS. 16-18, another configuration of a fourth adapter 406 (e.g., a bracket) is shown, according to some embodiments. The fourth adapter 406 can be used on a refuse vehicle 10 that is configured to tip individual residential refuse containers to empty refuse therein. The configuration of the refuse vehicle 10 (e.g., the tailgate 34) for the residential containers does not include a kick bar and includes steps 126 adjacent an area where the residential containers are loaded onto the lift assembly 40. The fourth adapters 406 are shown installed on a flush-mounted tipper arrangement where the lift assemblies 40 are flush mounted.

The fourth adapters 406 are similar to the first adapters 106, and include a first plate 412 that defines a first engagement surface, a medial portion 414, and a second plate 416 that defines a second engagement surface. The medial portion 414 extends between the first plate 412 and the second plate 416. Similar to the first adapter 106, the first plate 412 is angled in order to account for or correct for the angle of the brackets 100. The first plate 412 defines the first engagement or mating surface that contacts the bracket 100 and is coupled to the bracket 100 via fasteners that can extend through openings 418 in the first plate. The second plate 416 defines the second engagement or mating surface that includes slots 420 and is configured to couple with the lights 108 in the vertical orientation (as shown in FIG. 16) via fasteners. However, unlike the first adapter 106, the first plate 412 and the second plate 416 both extend from a same side of the medial portion 414. The first plate 412 and the second plate 416 can extend in a laterally inwards direction such that, when installed on the tailgate 34, the first plates 412 extend in a direction from the medial portions 414 towards each other (e.g., laterally outwards). Likewise, the second plates 416 extend from the medial portions 414 in the laterally inwards direction towards each other (e.g., towards a center of the tailgate 34, towards the lift assemblies 40, etc.). The openings 418 can have a sizing and spacing (e.g., a bolt hole pattern) corresponding to (e.g., substantially the same as) the openings 107 of the brackets 100. In some embodiments, the openings 418 and/or the slots 420 are similarly configured such that the sizing and spacing corresponds to the openings 107 of the brackets 100. The fourth adapters 406 are configured for the flush-mounted tipper arrangement where the tailgate 34 does not include a kicker bar, whereas the other adapters described are configured for various configurations that include kicker bars.

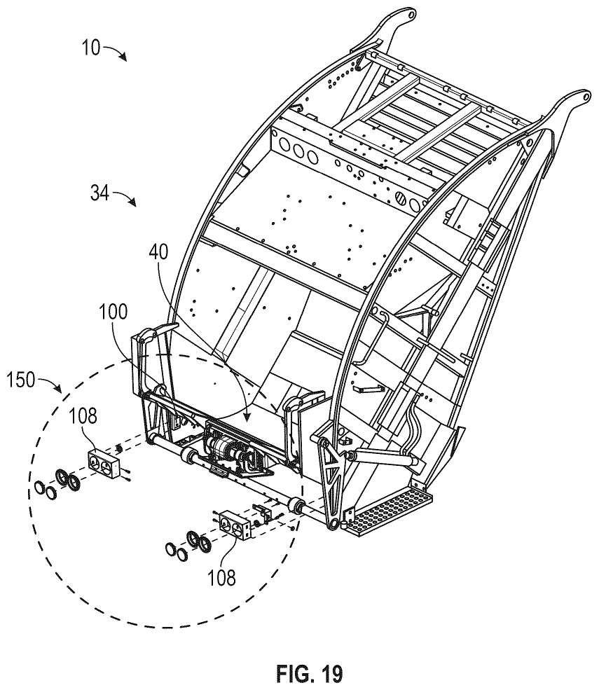

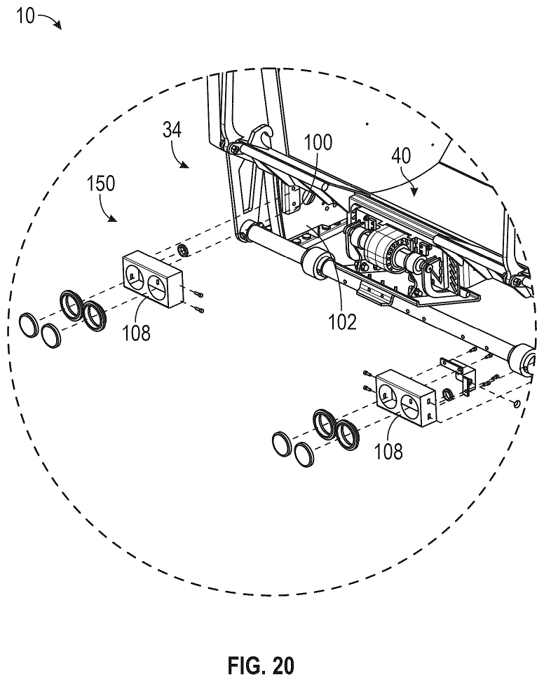

Referring to FIGS. 19 and 20, the lights 108 can be directly coupled to the brackets 100. As shown in FIGS. 19 and 20, the housings 122 of the lights 108 can be configured to directly contact the engagement surface defined by the brackets 100. The brackets 100 can be coupled (e.g., fastened, welded, etc.) to an inwards facing surfaces of the frame members 102. As shown in FIG. 20, the lights 108 can be coupled on a top or bottom (e.g., a width of the rectangular shape of the housings 122, a shorter side of the rectangular shape of the housing 122, etc.) to the brackets 100 such that the light 108 is arranged in a horizontal orientation. As shown in FIG. 7, the housings 122 of the lights 108 can have openings 128 disposed on an end 130. The openings 128 can have a size and spacing (e.g., a bolt hole pattern) corresponding to the size and spacing of the openings 107 of the brackets 100. As shown in FIG. 7, the housings 122 of the lights 108 can also have openings 134 that have a size and spacing (e.g., a bolt hole pattern) corresponding to the size and spacing of the openings 107 of the brackets 100, or more specifically, corresponding to the size and spacing of the bolt hole patterns on the second engagement surfaces of all of the adapters (e.g., the adapters 106, the adapters 206, the adapters 306, the adapters 406, the adapters 506, etc.). The lights 108 can be directly coupled to the brackets 100 in an extra-compaction (“XC”) or a heavy duty (“HD”) tailgate that has additional room for the lights 108 and does not require an adapter.

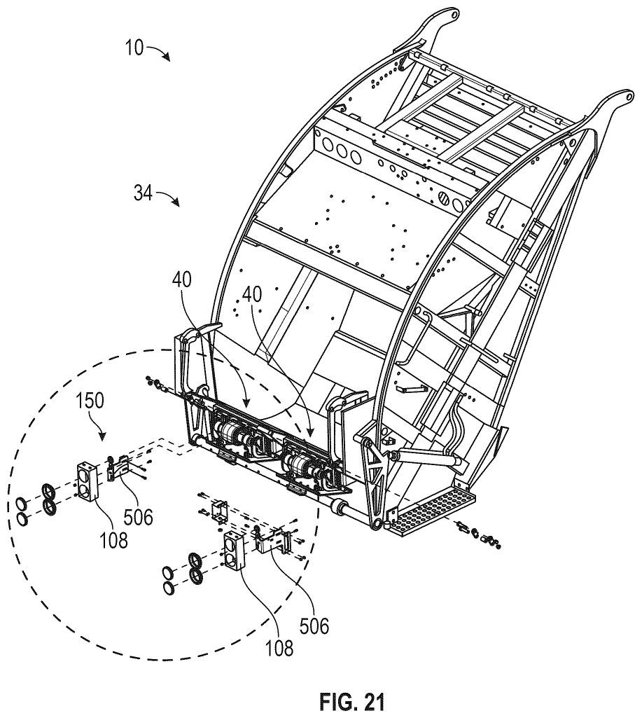

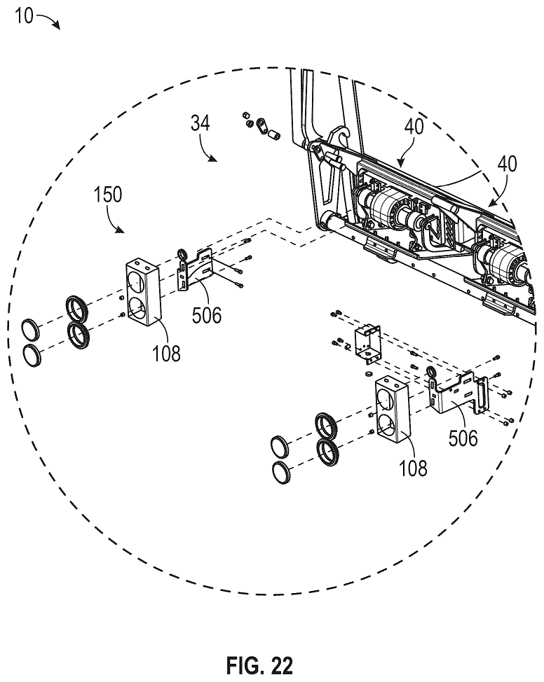

Referring to FIGS. 21 and 22, the lights 108 can be provided in a vertical orientation via fifth adapters 506 (e.g., brackets). The fifth adapters 506 are configured to couple with an inwards facing surface of the frame members 102. In some embodiments, the fifth adapters 506 are fastened directly to the frame members 102. In some embodiments, the fifth adapters 506 are coupled (e.g., fastened) to the brackets 100.

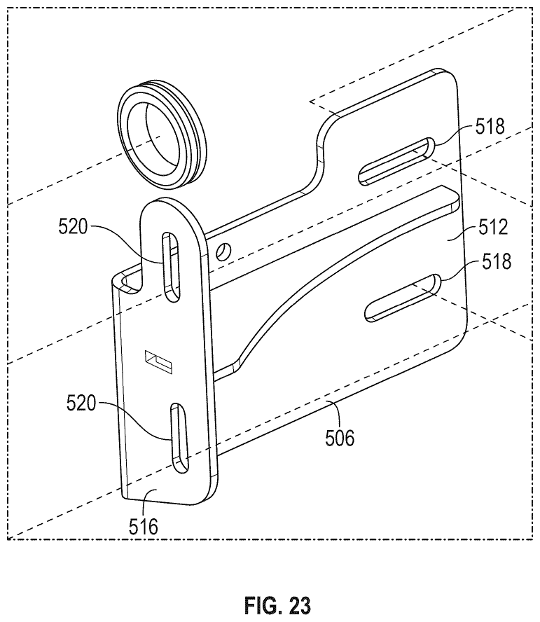

As shown in FIG. 23, the fifth adapters 506 include a first plate 512 and a second plate 516. The first plate 512 and the second plate 516 are perpendicular to each other, with the second plate 516 extending normal to the first plate 512 at an end of the first plate 512. The first plate 512 includes first openings 518 (e.g., apertures, holes, slots, etc.) and the second plate 516 includes second openings 520 (e.g., apertures, holes, slots, etc.). The first openings 518 and the second openings 520 are perpendicular to each other with the second openings 520 disposed in a vertical orientation. The first openings 518 facilitate coupling the fifth adapter 506 to the brackets 100 or the frame members 102 via fasteners. The second openings facilitate coupling the fifth adapter 506 with the lights 108 such that the lights 108 are disposed in a vertical orientation. The openings 518 can have a sizing and spacing (e.g., a bolt hole pattern) corresponding to (e.g., substantially the same as) the openings 107 of the brackets 100. In some embodiments, the second openings 520 are similarly configured such that the sizing and spacing corresponds to the openings 107 of the brackets 100.

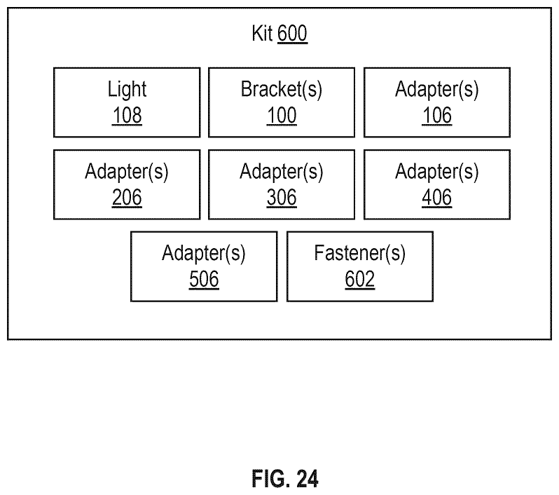

Referring to FIG. 24, the lights 108, the brackets 100, and one or more of the first adapters 106, the second adapters 206, the third adapters 306, the fourth adapters 406, and the fifth adapters 506 can be provided in a kit 600. The kit 600 can also include one or more fasteners 602 in order to assemble the lighting assembly 150 as described in greater above with reference to FIGS. 3-23. The kit 600 can be provided such that manufacturing or assembly personnel can install an appropriate adapter for a specific configuration of the tailgate 34 (e.g., for a specific configuration of the lift apparatus 40). In some embodiments, the adapters can easily be removed and replaced with a same configuration of adapter or a different adapter when the vehicle 10 is serviced. In some embodiments, one or more adapters can be custom-made for a specific configuration of the tailgate 34. However, the tailgate 34 can be equipped with a common bracket 100 having a universal mounting surface and arrangement (e.g., a universal size and spacing of openings for fasteners) such that the adapters can be interchanged with each other without requiring replacement of the brackets 100. In some embodiments, the adapters and the bracket 100 having fasteners and the universal configuration facilitates improved serviceability of the refuse vehicle 10. Other tailgates 34 have welded lighting assemblies that require cutting, grinding, and re-welding in order to replace the lighting assemblies. Advantageously, the lighting assembly 150 uses adapters that bolt onto a bracket with a universal configuration in order to facilitate easy service and inter-operability between various adapters.

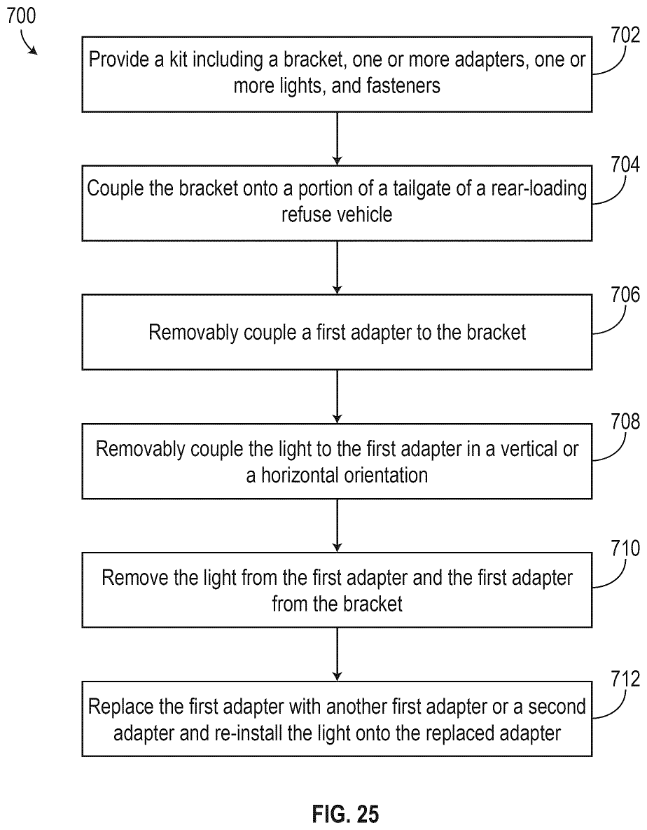

Referring to FIG. 25, a flow diagram of a method 700 for installing and servicing or replacing an adapter of the lighting assembly 150 includes steps 702-712, according to some embodiments. The method 700 includes providing a kit including a bracket, one or more adapters, one or more lights, and fasteners (step 702), according to some embodiments. In some embodiments, the kit is the kit 600 as described in greater detail above with reference to FIG. 23. The kit can include multiple adapters of a same type (e.g., multiple of first adapter 106 in both a left and right configuration, or more specifically, adapters that are mirror images of each other for driver and passenger sides of the tailgate 34), and/or multiple adapters of various types (e.g., adapters 106, adapters 206, adapters 306, etc.). In some embodiments, the adapters provided in the kit include two engagement surfaces, one of which is configured to engage the bracket and another of which is configured to engage the light. The two engagement surfaces can be disposed in different planes in order to provide various orientations and positions of the light when the lighting assembly is fully assembled.

The method 700 includes coupling the bracket onto a portion of a tailgate of a rear-loading refuse vehicle (step 704), according to some embodiments. In some embodiments, the bracket is the bracket 100 and is configured to provide a universal mounting surface (e.g., predetermined hole sizes and spacing for fasteners). The step 704 can include providing the bracket onto the tailgate and installing fasteners to couple the bracket onto the tailgate. In some embodiments, the step 704 includes welding the bracket onto the tailgate. The bracket can be provided onto the tailgate at a position based on an arrangement of the tipper or lift assembly. For example, for a flush-mounted tipper that does not include a kicker bar, the brackets can be welded to the tailgate at a lower position than for tailgates that include kicker bars.

The method 700 includes removably coupling a first adapter to the bracket (step 706), according to some embodiments. In some embodiments, step 706 includes installing fasteners to removably couple the first adapter onto the bracket (e.g., onto the universal mounting structure provided by the bracket). The step 706 can include providing the first engagement surface of the adapter onto the bracket and fastening (e.g., using nuts and bolts) the adapter to the bracket. The adapter that is used in step 706 can be selected from various adapters based on a specific configuration of a tipper assembly or lift assembly of the tailgate. For example, certain lift assemblies may take up more space on the tailgate and may therefore require different adapters in order to facilitate proper viewing of lights. In another example, if the refuse vehicle 10 has a dual tipper arrangement or a street side or curb-side application, the first adapters 106, the third adapters 306, the fourth adapters 406, or the fifth adapters 506 can be used in order to result in the lights 108 being oriented vertically.

The method 700 includes removably coupling the light to the first adapter in a vertical or horizontal orientation (step 708), according to some embodiments. In some embodiments, step 708 includes providing the light (e.g., a housing of the light) onto the second engagement surface of the adapter in either a horizontal or a vertical orientation and installing fasteners to couple the light onto the adapter.

The method 700 includes removing the light from the first adapter and the first adapter from the bracket (step 710), according to some embodiments. In some embodiments, step 710 includes uninstalling or removing the fasteners from the engagement between the second engagement surface of the adapter and the light, and also uninstalling or removing the fasteners from the engagement between the first engagement surface of the adapter and the bracket. In some embodiments, step 710 is performed in response to an upgrade to the tailgate (e.g., installation of a different lift or tip assembly that has different size) or in response to one or more of the lights failing, being damaged, or otherwise requiring servicing.

The method 700 also includes replacing the first adapter with another first adapter or with a second adapter and re-installing the light onto the replaced adapter (step 712), according to some embodiments. In some embodiments, step 712 includes performing steps 704-708 using another first adapter or with a different adapter (e.g., the second adapters 206, the third adapter 306, etc.) depending on the reason for servicing. For example, if the tailgate 34 is being modified to include an upgraded tipper assembly (e.g., a new lift assembly 40), the first adapter can be replaced with a different adapter (e.g., a second or third adapter) from the kit.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A refuse vehicle, comprising:
a tailgate including a lift apparatus configured to raise a refuse container and empty contents of the refuse container into a hopper;
a lighting assembly, including:
a bracket coupled with a frame of the tailgate, the bracket defining a plurality of openings having a universal size and spacing;
a first adapter including:
a first plate defining a first engagement surface and having a first plurality of openings corresponding in size and spacing to the plurality of openings of the bracket; and
a second plate defining a second engagement surface and having a second plurality of openings; and
wherein the first plate and the second plate are disposed in different planes relative to each other; and
a light including a housing having a plurality of openings corresponding in size and spacing to the second plurality of openings in the second plate.

2. The refuse vehicle of claim 1, wherein the first adapter includes a medial portion extending between the first plate and the second plate, wherein the first plate and the second plate of the first adapter extend from opposite sides at opposite ends of the medial portion in directions perpendicular to the medial portion.

3. The refuse vehicle of claim 1, wherein the first adapter includes a medial portion extending between the first plate and the second plate, wherein the first plate and the second plate of the first adapter extend from a same side at opposite ends of the medial portion in directions perpendicular to the medial portion.

4. The refuse vehicle of claim 1, wherein the bracket is configured to couple with the first adapter or a second adapter having a first plurality of openings corresponding in size and spacing to the plurality of openings of the bracket, wherein a second plate of the second adapter is disposed in a different plane than a plane in which the second plate of the first adapter is disposed, wherein a medial portion of the second adapter is longer than the medial portion of the first adapter to result.

5. The refuse vehicle of claim 1, wherein the bracket is a universal bracket that is configured to couple with a plurality of different adapters having openings corresponding in size and spacing to the plurality of openings of the bracket to reposition the light in a plurality of various positions or orientations.

6. The refuse vehicle of claim 1, wherein the bracket is configured to couple with the first adapter or a second adapter having a first plurality of openings corresponding in size and spacing to the plurality of openings of the bracket, wherein a second plate of the second adapter is disposed in a different plane than a plane in which the second plate of the first adapter is disposed.

7. The refuse vehicle of claim 1, wherein the first adapter is configured to position the light laterally outwards from the bracket.

8. A kit for a lighting assembly, the kit comprising:
a bracket comprising a universal bolt hole pattern;
a plurality of adapters, the plurality of adapters having (i) a first engagement surface configured to abut the bracket and including a plurality of first openings corresponding in sizing and spacing to the universal bolt hole pattern, and (ii) a second engagement surface having a plurality of second openings; and
a light having a housing configured to be fastened to a second engagement surface of the plurality of adapters in a vertical orientation or a horizontal orientation, the housing including a plurality of openings having bolt hole patterns corresponding to a bolt hole pattern of the plurality of second openings of the plurality of adapters;
wherein the plurality of adapters are interchangeable with each other on the bracket; and
wherein the plurality of adapters result in the light, when assembled, being in a different position or orientation.

9. The kit of claim 8, wherein the plurality of adapters includes a first adapter, the first adapter including a first plate having an angle corresponding to the bracket, a medial portion, and a second plate, the second plate angled relative to the first plate such that, when the first adapter is installed on a refuse vehicle, the light is oriented in a vertical direction and faces rearwards.

10. The kit of claim 9, wherein the plurality of adapters includes a second adapter, the second adapter including a first plate and a second plate, the first plate having an angle corresponding to the bracket, the second plate angled relative to the first plate such that, when the second adapter is installed on the refuse vehicle, the light is oriented in a horizontal direction and faces rearwards.

11. The kit of claim 10, wherein the plurality of adapters includes a third adapter, the third adapter including a first plate having an angle corresponding to the bracket, a medial portion, and a second plate, the second plate angled relative to the first plate such that, when the third adapter is installed on the refuse vehicle, the light is oriented in a vertical direction and faces rearwards, the medial portion of the third adapter being longer than the medial portion of the first adapter.

12. The kit of claim 11, wherein the plurality of adapters includes a fourth adapter, the fourth adapter including a first plate having an angle corresponding to the bracket, a medial portion, and a second plate, the second plate angled relative to the first plate such that, when the third adapter is installed on the refuse vehicle, the light is oriented in a vertical direction and faces rearwards, wherein the first plate and the second plate extend from a same side of the medial portion.

13. The kit of claim 12, wherein the plurality of adapters includes a fifth adapter, the fifth adapter including a first plate and a second plate, the first plate and the second plate being perpendicular to each other, wherein the first plate includes a first pair of slots and the second plate includes a second pair of slots, the first pair of slots and the second pair of slots perpendicular with each other such that the light is capable of being repositioned in a plurality of directions.

14. The kit of claim 8, further comprising a plurality of fasteners, wherein the plurality of fasteners are configured for use with any of the plurality of adapters to (i) couple the light to any of the plurality of adapters, (ii) couple any of the plurality of adapters to the bracket, and (iii) couple the bracket to a refuse vehicle.

15. A lighting assembly for a refuse vehicle, the lighting assembly comprising:
a bracket coupled with a frame of a tailgate of the refuse vehicle, the bracket defining a plurality of openings having a universal size and spacing;
a first adapter including:
a first plate defining a first engagement surface and having a first plurality of openings corresponding in size and spacing to the plurality of openings of the bracket; and
a second plate defining a second engagement surface and having a second plurality of openings; and
wherein the first plate and the second plate are disposed in different planes relative to each other; and
a light including a housing having a plurality of openings corresponding in size and spacing to the second plurality of openings in the second plate.

16. The lighting assembly of claim 15, wherein the first adapter includes a medial portion extending between the first plate and the second plate, wherein the first plate and the second plate of the first adapter extend from opposite sides at opposite ends of the medial portion in directions perpendicular to the medial portion.

17. The lighting assembly of claim 15, wherein the first adapter includes a medial portion extending between the first plate and the second plate, wherein the first plate and the second plate of the first adapter extend from a same side at opposite ends of the medial portion in directions perpendicular to the medial portion.

18. The lighting assembly of claim 15, wherein the bracket is a universal bracket that is configured to couple with a plurality of different adapters having openings corresponding in size and spacing to the plurality of openings of the bracket to reposition the light in a plurality of various positions or orientations.

19. The lighting assembly of claim 15, wherein the bracket is configured to couple with the first adapter or a second adapter having a first plurality of openings corresponding in size and spacing to the plurality of openings of the bracket, wherein a second plate of the second adapter is disposed in a different plane than a plane in which the second plate of the first adapter is disposed.

20. The lighting assembly of claim 15, wherein the bracket is configured to couple with the first adapter or a second adapter having a first plurality of openings corresponding in size and spacing to the plurality of openings of the bracket, wherein a second plate of the second adapter is disposed in a different plane than a plane in which the second plate of the first adapter is disposed, wherein a medial portion of the second adapter is longer than the medial portion of the first adapter.
